(19) United States
(12) Patent Application Publication
(10) Pub. No.: US 2008/0032650 A1
(43) Pub. Date: Feb. 7, 2008

(54) Integrated Bluetooth-FM "xrBlue" Adapter

(76) Inventors: Yujie Zhang, Gardena, CA (US); Charles Morton, Redondo beach, CA (US)

Correspondence Address: Charles Morton, 1919 Grant Ave #A, Redondo Beach, CA, 90278, US

(21) Appl. No.: 11/760,454

(22) Filed: Jun. 8, 2007

Related U.S. Application Data
(60) Provisional application No. 60/835,124, filed on Aug. 3, 2006.

(51) Int. Cl. H04B 1/18

(52) U.S. Cl. 455/185.1

(57) ABSTRACT

“xrBlue” adapter is a integrated Bluetooth-FM adapter that plugs into a car cigarette lighter socket, enabling in-car cable-free hands-free Bluetooth for every kind of Bluetooth-enabled devices including cell phone, MP3 player, iPod, navigation system etc. The “xrBlue” adapter comprises of five components: Bluetooth module to automatically detect and establish communication with the Bluetooth enabled apparatus; FM module for configuring to tune to the car radio FM channel and play via the car stereo system; power module to plug-in the car cigarette lighter socket; optional power plug-in extension socket to provide the power pass-through for additional electronic device; optional retractable wired microphone or Bluetooth microphone. The “xrBlue” adapter differentiates from previous art in that: this unique integrated Bluetooth-FM design synergy communication, entertainment, and navigation into all-in-one Bluetooth solution; this device does not rely on out-of-date cassette tape player and is ready to use by simply starting the car with the device inserted into the car cigarette lighter socket; there is no worry of battery life since it is directly plug-in the cigarette lighter socket for constant supply of power.

### CROSS-REFERENCE TO RELATED APPLICATIONS

A provisional patent was submitted by the inventors and received by the USPTO with application No. 60/835,124, filing date Aug. 3, 2006 and confirmation number 8642, with title “Car cigarette lighter socket plug-in Bluetooth enabling device BluetoothEverywhere”.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF INVENTION

The invention relates generally to the Bluetooth enabling device to achieve the in-car hands-free profile. More specifically, the invention is particularly an in-car Bluetooth enabling device inserted into cigarette lighter socket and utilize the car entertainment system (e.g., sound system, video screen) to communicate with any kind of Bluetooth enabled device (e.g., cell phone, MP3 player, iPod, etc.)

Bluetooth is becoming an essential part of in-car hands-free communication solution and in-car entertainment and navigation interface. The hands-free profile provides a convenient in-car solution and very critical in terms of application safety. CNN reports that study discloses that cell phone use is the most common distraction for drivers, with statistics showing cell phone dialing triples the risk of a car accident

(http://www.cnn.com/2006/US/04/20/driving.study/index.html).

At the time of this invention, the hands-free communication and in-car entertainment solutions are as follows: the cell phone hands-free solution is either through vehicle built-in Bluetooth or stand-alone cell phone Bluetooth kit; the iPod/Mp3 player is connected to a wire-based audio interface to play the audio.

U.S. Pat. No. 20,030,224,726 disclosed a Bluetooth cassette-like device for a hands-free cell phone kit. The device comprises of a Bluetooth module that automatically detects and establishes communication with a Bluetooth enabled device. A circuit module transfers communication data into magnetic signal, with a transducer converting the magnetic signal into tape. When the device is inserted into the tape player, the device automatically initiates communication with a Bluetooth enabled device, converting the communication data into audio, and playing it via the car stereo. The Bluetooth enabling technique disclosed in this previous invention is based on the tape player, which has become out-of-date and may not exist in many vehicles.

This invention disclosed in this patent presents a Bluetooth enabling device which is FM radio based instead of relying on tape player. The device applies for most vehicles, being powered through a cigarette lighter power socket. The invention provides a synergistic solution for all kinds of in-car communication, entertainment and navigation use. This allows a 100% “cable-free” “hands-free” in-car profile, significantly improving application safety, while enriching the in-car entertainment and navigation conduit.

### BRIEF SUMMARY OF INVENTION

The unique design concept and implementation techniques of the “xrBlue” adapter enables a simple hands-free in-car Bluetooth solution without relying on a cassette player and/or external power/charging supply. The “xrBlue” adapter is both backward and forward compatible to existing and future vehicles. The technique utilizes a Bluetooth/FM based approach to provide a sleek design and implementation of the in-car Bluetooth solution. In addition, the “xrBlue” adapter provides the option to extend the power plug-in, so that the additional electronics can use in-car power.

The “xrBlue” adapter automatically detects the Bluetooth enabled device and autonomously establishes communication and switch to car audio system when answering an incoming call, dialing a call, playing iPod etc.

### BRIEF DESCRIPTION OF THE SEVERAL VIEWS OF THE DRAWING

The invention is described in detail with the respective drawings:

FIG. 1 is a basic unit of the invention;

FIG. 2 is an extended version of a basic unit of the invention having a power pass-through; and,

FIG. 3 is another extended version of a basic unit of the invention with retractable wired microphone; and,

FIG. 4 is a deluxe unit of the invention with Bluetooth microphone.

### DETAILED DESCRIPTION OF THE INVENTION

The unique design and simple implementation enables the next generation in-car hands-free cable-free communication, entertainment and navigation solution. In comparison with the previous art of Bluetooth enabling device, the “xrBlue” adapter gains advantages as the following aspects:
The “xrBlue” technique synergizes communication, entertainment, and navigation into all-in-one Bluetooth solution.
The “xrBlue” adapter is designed to plug-in the cigarette lighter socket and is FM based, which does not rely on cassette tape player or a hard wired connection.
The “xrBlue” adapter is ready to use by simply starting the car with the device inserted into the car cigarette lighter socket; there is no worry of battery life since it is directly plug-in the cigarette lighter socket for constant supply of power.

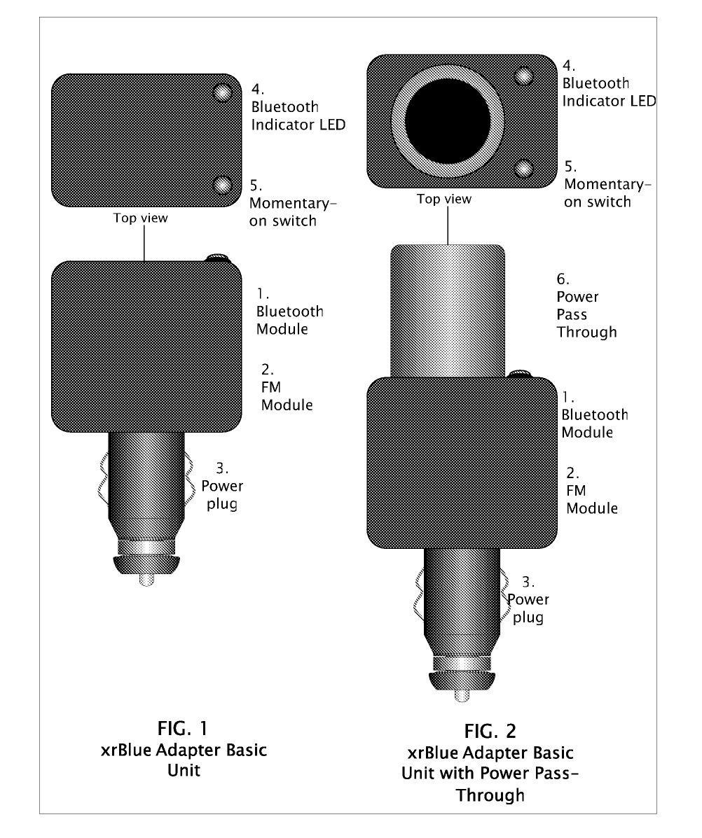

FIG. 1 illustrates the basic unit that consists of a Bluetooth Module as module 1, a low power FM Transmitter as module 2, and basic logic controller to control transfer audio from the Bluetooth module to be modulated by the FM transmitter to be received by a standard FM car stereo and played through its speaker system. The basic unit has one momentary-on micro switch, as component 4 in the drawing, to provide power off/on, FM frequency selection and basic control of the Bluetooth module. Additionally a blue LED, as component 5 in the drawing, is provided to provide power on and status information. The primary functionality of this unit is to supply audio players, GPS devices, etc. that have Bluetooth capability with the ability to stream audio via a standard FM receiver.

Powering the device on or off is accomplished by pressing and holding the micro-switch, as component 4, for a period of 2 to 4 seconds.

Pairing of the device is accomplished via holding the micro-switch down for a set period of time greater than 10 seconds, setting the device into discovery mode. Each device will have a built in ID to allow identification. After 60 seconds of inactivity the unit will revert to normal operation.

Selecting FM transmitter frequency shall be accomplished by holding the micro-switch down for 5-7 seconds where the blue LED will flash in a series of quick flashed from 1 to N indicating which frequency (from 1 to N) the FM transmitter is set. Frequency selection can then be cycled by momentarily pressing the micro-switch by the number of times the user wants to increment the frequency. After 20 seconds of inactivity the unit will revert to normal operation.

When the unit is paired with a cell phone, momentarily pressing the micro-switch will allow the unit to connect or disconnect a call.

FIG. 2 shows the Basic Unit with Power Pass-through. This unit consists of the same configuration of the basic unit with the addition of an inline extension of the cigarette lighter power socket as module 6. This design provides the power socket to other electronic device.

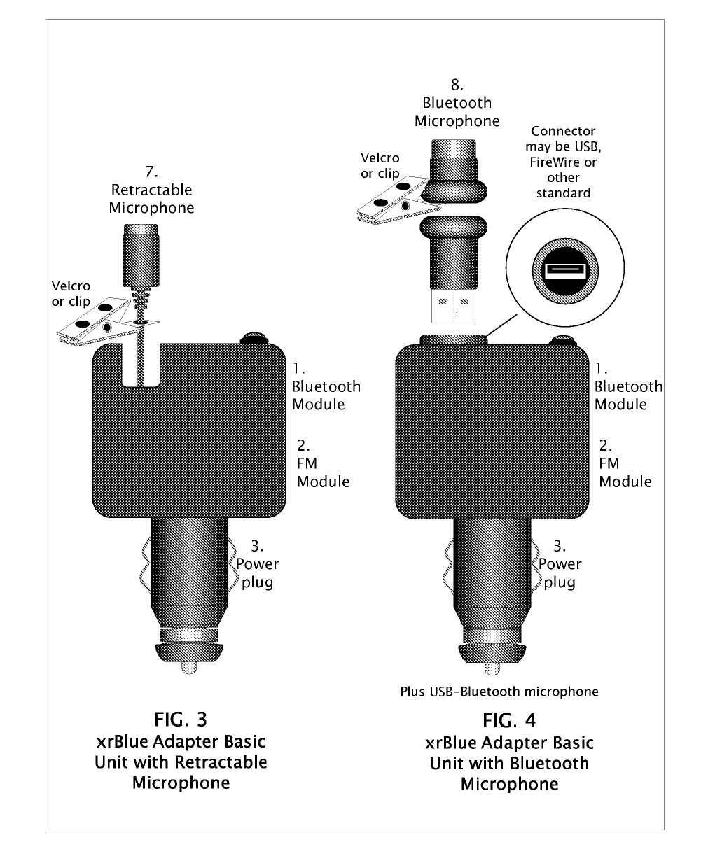

FIG. 3 demonstrates the Basic Unit with an integrated retractable wired microphone as module 7. This design provides a low cost means for Bluetooth enabled cell phone use. Pairing of the Bluetooth enable device (e.g., cell phone, MP3 player, iPod etc.) to the “xrBlue” adapter is accomplished using the momentary-on switch to complete the handshake.

FIG. 4 presents the Deluxe Unit with Bluetooth Microphone as module 8. This unit provides the same functionality as FIG. 3 with the added functionality of a cordless Bluetooth microphone. The microphone connects to the Unit via a USB or similar connector. The purpose of the connector is to provide power to charge the microphone when not in use. All communication between the microphone and the “xrBlue” adapter is via a preset Bluetooth pairing of the microphone and the Bluetooth module as module 1.

What is claimed is:

1. The “xrBlue” adapter is a car cigarette lighter socket plug-in Bluetooth enabling device which enables in-car Bluetooth for any kind of Bluetooth enabled apparatus.

2. The “xrBlue” adapter seamlessly synergize a group of techniques: Bluetooth module to automatically detect and establish communication with the wireless apparatus; FM module for configuring to tune to the car radio FM channel and play via the car stereo system; power module to plug-in the car cigarette lighter socket; optional power plug-in extension socket to provide the power for additional electronic device; optional retractable wired microphone or Bluetooth microphone.

3. The device of claim 2 wherein said “communication” includes multimedia communication, including text, audio, video etc., via the Bluetooth protocol.

4. The device of claim 2 wherein said “any kind of Bluetooth enabled apparatus” includes all the Bluetooth enabled devices such as cell phone, MP3 player, iPod, navigation system etc.

5. The device of claim 2 wherein said “Bluetooth module” automatically detects and establishes communication with the Bluetooth enabled devices.

6. The device of claim 2 wherein said “FM module”, includes a low power FM Transmitter, and basic logic controller to control transfer audio from the Bluetooth module to be modulated by the FM transmitter to be received by a standard FM car stereo and played through its speaker system.

7. The device of claim 2 wherein said “power module”, is an inline extension of cigarette lighter power.

8. The device of claim 2 wherein said “optional retractable wired microphone or Bluetooth microphone”, connects to the Unit via a USB or similar connector, where the connector is to provide power to charge the microphone when not in use.
